(19) United States
(12) Patent Application Publication
(10) Pub. No.: US 2006/0059609 A1
(43) Pub. Date: Mar. 23, 2006

(54) Self-adhesive protective padding device

(76) Inventor: Perry Victor Moss, Marietta, GA (US)

Correspondence Address: Davis Register LLP, Suite 204, 464 Cherokee Ave. SE, Atlanta, GA, 30312, US

(21) Appl. No.: 10/943,631

(22) Filed: Sep. 17, 2004

(51) Int. Cl. A41D 13/015; A62B 17/00

(52) U.S. Cl. 2/455

(57) ABSTRACT

A self adhesive protective padding device having a plurality of pads able to be adhered precisely to the hip and lower back areas of the body, wherein the padding being light weight and disposable, consisting of multi-layer air-filled material, is designed to protect the body from hip and bone fracture due to falls.

### FIELD OF THE INVENTION

The present invention relates to a protective device. It is particularly concerned with protection of the femur head, the iliac crest, the lower lumbar region, the coccyx, and the sacrum of the person using the device.

### BACKGROUND OF THE INVENTION

Hip fractures are a health problem of enormous proportion. Approximately 250,000 hip fractures occur annually in the United States, resulting in an estimated annual cost of over seven billion dollars in medical and nursing services. In the United States, the average cost of a hip fracture for all age groups in 1984 was $29,800.

Over 98% of hip fractures are caused by falls. Growing evidence suggests that the strongest determinant of hip fracture risk in the event of a fall is the kinematical state of the body at the moment of impact. A simple fall from a standing height has several times the potential energy required to fracture a healthy hip.

In order for a fall from a standing height to cause a hip fracture, four conditions must be met: (1) The subject must be oriented to land on the hip; (2) Protective responses must be inadequate to reduce the energy of the fall below the critical threshold; (3) Local shock absorbers such as fat and muscles around the hip must be inadequate to reduce the energy of the fall below the critical threshold; and (4) Bone strength in the proximal femur must be insufficient to resist the residual energy of the fall that is transmitted to the hip.

Due to the inevitability of the first condition and the immutability of the fourth condition, previous protective devices have focused on the second and third conditions. These devices seek to prevent injuries to the lower lumbar, hip and pelvis regions through the use of various padding agents such as gel or closed-cell foam.

Previous devices have utilized thick pads that are placed inside pockets of a garment. The pockets often shift positions in relation to the user's body causing discomfort, poor protection, and restriction of movement. Other devices use belts or connecting members to hold pads in place with the same problematic results.

The problem with these devices is that they are bulky, expensive, and limited in mobility, generally targeting geriatric patients. In today's active society falling occurs in all ages and genders and across a wide range of traditional and new “extreme” sports such as in-line skating, skiing, skateboarding, field hockey, extreme Frisbee, basketball, ice skating, mountain biking, gymnastics, volleyball, etc.

### BRIEF SUMMARY OF THE INVENTION

The present invention provides an inexpensive, disposable, lightweight and easy-to-use device that appeals to all ages and genders. The present invention relates to a device for protecting various areas of a user's body. It is particularly concerned with a device for protecting the hipbones, femur, lower lumbar region of the spine, coccyx, and sacrum through the use of self-adhesive pads.

The key to the present invention is the lightweight, self-adhesive pads that make up the device. In order for protective devices to appeal to all users and not just older users, the devices must be lightweight, easily fitted, cost-effective and non-bulky with ample freedom of movement.

The present invention allows pads to be precisely placed in a manner consistent with the user's bodily dimensions as the pads may adhere directly to the skin or garments of the user. Because the pads adhere to the location of primary placement, the pads will not shift position during use, thus increasing the likelihood of adequate protection and appeal to all users.

Young users also express distaste for devices that must be stepped into, such as a protective pair of shorts. The present invention eliminates that problem by allowing users to simply press the pads into position.

In one embodiment, the present invention uses extremely lightweight pads comprised of low-density polyethylene (LDPE) and high-density polyethylene (HDPE) held together by a means such as pre-wrap, soft foam, or any suitable adhesive. The LDPE and HDPE layers contain air bubbles and/or air-filled tubules. When a user impacts with the ground or perhaps an opponent, the air bubbles rupture, thus dispersing the impact force and signaling that the pad has outlived its usefulness and should be replaced.

Unlike foam or gel pads, the “air bubble” pads' lightweight nature allows users to increase protection without sacrificing speed and ease of movement.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a side view of an embodiment of the device.

FIG. 2 is a rear view of an embodiment of the device.

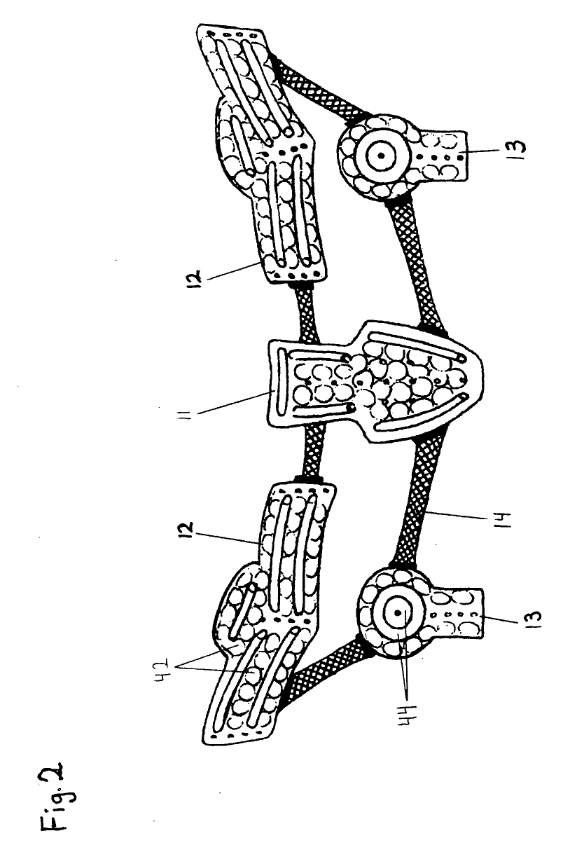

FIG. 3 is a cross-sectional view of a pad in one embodiment of the device

### DETAILED DESCRIPTION OF THE INVENTION

In describing the preferred and alternate embodiments of the present invention, as illustrated in the figures and/or described herein, specific terminology is employed for the sake of clarity. The invention, however, is not intended to be limited to the specific terminology so selected, and it is to be understood that each specific element includes all technical equivalents that operate in a similar manner to accomplish similar functions.

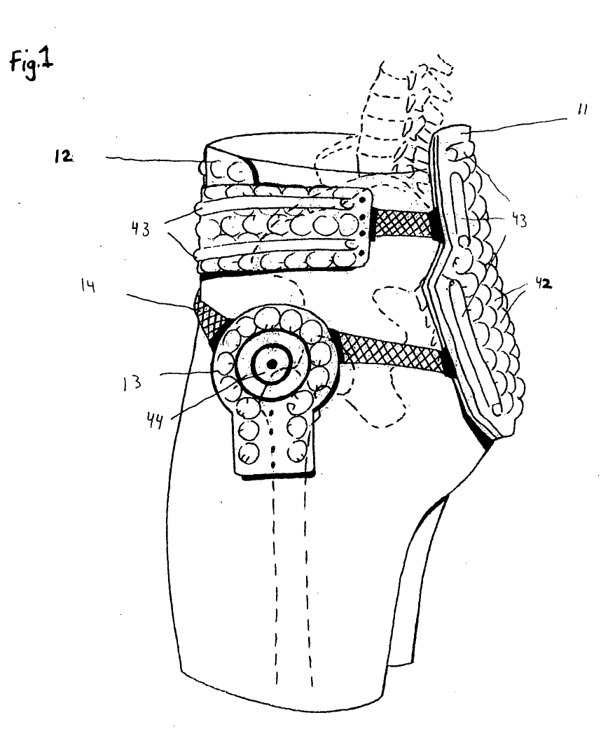

Referring now to FIG. 1, the present invention in a preferred embodiment uses five pads 11, 12, 13 and a mesh netting 14 for connecting the pads. In the preferred embodiment, two hip pads 12 substantially cover the iliac crest, anterior superior iliac spine, and posterior superior iliac spine. Two femur head pads 13 substantially cover the greater trichinae region. The rear pad 11 covers the lower lumbar spinal process, the transverse processes of the sacrum, and the upper area of the coccyx. The pads are connected to each other by the mesh netting 14.

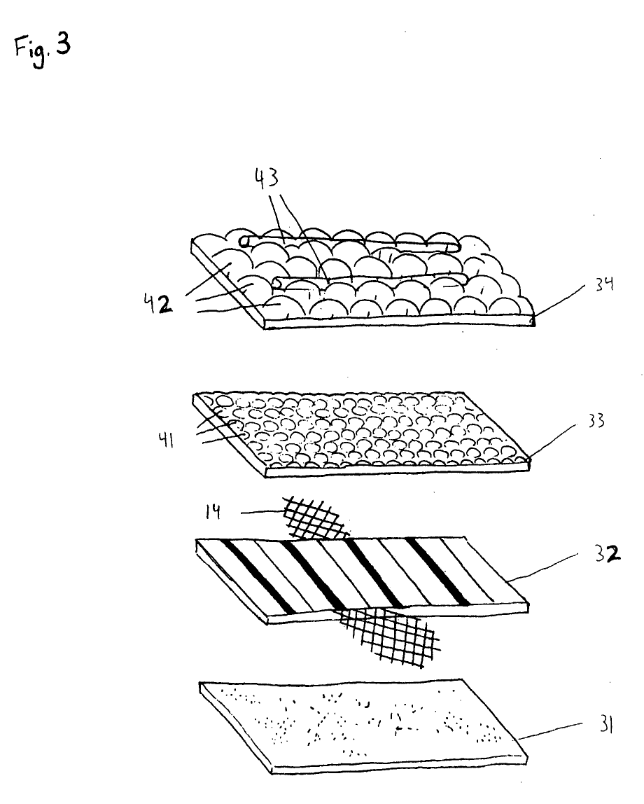

FIG. 3 shows the general composition of the pads 11, 12, 13. The first layer 31 is the inner layer that faces the body of the user. The first layer 31 is an adhesive such as Kinesio-Tex tape for securing the pad to the user's body or clothes. Although the preferred embodiment uses Kinesio-Tex tape, any substance capable of adhering to the user's body or clothes may be used. In the preferred embodiment, the second layer 32 is a thin, foam sheet made out of polyethylene. The mesh netting 14 is connected to the foam. Although the preferred embodiment uses a polyethylene second layer 32, any suitable substance such as polystyrene or Cushion-Lite™ may be used.

In the preferred embodiment, the third layer 33 is a sheet of low-density polyethylene having small bubbles 41 dispersed inside the polyethylene such that the layer 33 is similar to everyday “bubble wrap.” The small bubbles function to absorb the shock of an impact upon the user. Although the preferred embodiment uses low-density polyethylene for the third layer 33, any suitable substance such as polystyrene, high-density polyethylene, or blends thereof may be used. And although the preferred embodiment uses bubbles filled with ambient air, the bubbles could be filled by any substance capable of absorbing shock such as gel, or pressurized air.

In the preferred embodiment, the fourth layer 34 is a sheet of high-density polyethylene having larger bubbles 42 relative to the third layer 33 dispersed inside the polyethylene such that the layer 34 is similar to everyday “bubble wrap.” Although the preferred embodiment uses high-density polyethylene for the fourth layer 34, any suitable substance such as polystyrene, low-density polyethylene, Air Cushion™ or blends thereof may be used.

In the case of the rear pad 11 and the hip pads 12, the fourth layer 34 also has convoluted, air-filled tubules 43 for providing protection against the forces of impact upon a user. In the case of the femur head pads 13, the fourth layer has at least one concentric, air-filled tubule that is placed over the femur head for dispersing the force of an impact upon a user. Although the convoluted tubules and the concentric tubules in the preferred embodiment are filled with ambient air, any suitable substance such as gel or pressurized air may be used.

In the preferred embodiment the rear pad 11 extends vertically upward from the upper end of the coccyx to the lower lumbar spinal process. The rear pad 11 extends horizontally to substantially protect the transverse processes of the sacrum. Convoluted tubules 43 are placed along the periphery of the pad and air bubbles 42 fill the space between the periphery of the convoluted tubules 43.

In the preferred embodiment the hip pads 12 extend horizontally around the user's waist so as to substantially cover the iliac crest, anterior superior iliac spine, and posterior superior iliac spine. Convoluted tubules 43 horizontally extend along the length of the pads 12. Air bubbles 42 are dispersed around and between the convoluted tubules 43. Although the preferred embodiment shows two convoluted tubules being used, the number may vary as needed.

In the preferred embodiment the femur head pads 13 have a “keyhole” shape. The upper portion of the pad is circular with a rectangular depending lower portion. Concentric tubules 44 are placed in the center of the upper, circular portion of the pad 13 in a “bullseye” array. Air bubbles 42 are placed along the periphery of the pad and surrounding the “bullseye.” The number of concentric tubules 44 used in the “bullseye” array can be varied, two being the preferred number in this embodiment.

In the preferred embodiment, the five pads 11, 12, 13 are connected to each other by a mesh netting 14. The mesh netting allows a user to carry the pads around as a single device. Although the preferred embodiment includes all five pads, the mesh netting may be easily cut, allowing the user to utilize only those pads he/she needs to. In fact, the mesh netting need not be used at all as its main purpose is simply to hold the pads together for carrying purposes.

What is claimed is:

1. A device for protecting various areas of a user's body, the device comprising:
(a) a plurality of pads, said pads having an adhesive for adhering to a user's body or clothes; and
(b) a mesh netting for connecting the pads.

2. The device of claim 1 wherein said pads are comprised of a first layer of adhesive, a second layer that is a thin, foam sheet made out of polyethylene, a third layer of low density polyethylene, and a fourth layer of high density polyethylene, said third and fourth layers having a plurality of air bubbles dispersed inside the polyethylene.

3. The device of claim 1 wherein the adhesive is Kinesio-Tex tape.

4. The device of claim 1 wherein the adhesive is Oleoresin of Capsicum.

5. The device of claim 2 wherein the first layer of adhesive is Kinesio-Tex tape.

6. A device for protecting various areas of a user's body, the device comprising:
(a) a pair of self-adhesive hip area pads for substantially covering the iliac crest, anterior superior iliac spine, and posterior superior iliac spine;
(b) a pair of self-adhesive femur area pads for substantially covering the greater trochanteric region;
(c) a rear pad for substantially covering the lower lumbar spinal process, the transverse processes of the sacrum, and the upper area of the coccyx; and
(d) a mesh netting for connecting said pads to one another.

7. The device of claim 6 wherein the pair of self-adhesive hip area pads have a first layer of adhesive, a second layer that is a thin, foam sheet made out of polyethylene, a third layer of low density polyethylene, and a fourth layer of high density polyethylene, said third and fourth layers having a plurality of air bubbles dispersed inside the polyethylene, the self-adhesive hip area pads extending horizontally and vertically so as to substantially cover the iliac crest, anterior superior iliac spine, and posterior superior iliac spine, said fourth layer having at least one tubule extending horizontally along the self-adhesive hip area pads.

8. The device of claim 6 wherein the pair of self-adhesive femur area pads have a first layer of adhesive, a second layer that is a thin, foam sheet made out of polyethylene, a third layer of low density polyethylene, and a fourth layer of high density polyethylene, said third and fourth layers having a plurality of air bubbles dispersed inside the polyethylene, said self-adhesive femur area pads having a “keyhole” shape for substantially covering the greater trochanteric region of the hip, said fourth layer having at least one concentric tubule placed in the center of the upper, circular area of the “keyhole” shape.

9. The device of claim 6 wherein the rear pad has a first layer of adhesive, a second layer that is a thin, foam sheet made out of polyethylene, a third layer of low density polyethylene, and a fourth layer of high density polyethylene, said third and fourth layers having a plurality of air bubbles dispersed inside the polyethylene, said rear pad extending vertically upward from the upper end of the coccyx to the lower lumbar spinal process and extending horizontally to substantially protect the transverse processes of the sacrum, said fourth layer of the rear pad having a plurality of tubules placed around the periphery of the pad.

10. The device of claim 6 wherein the hip area pads, the femur area pads, and the rear pad use Kinesio-Tex tape as an adhesive.

11. A self-adhesive pad for protecting various areas of a user's body, the self-adhesive pad comprising:
(a) an adhesive inner layer;
(b) a thin polyethylene inner middle layer;
(c) a low-density polyethylene outer middle layer with a plurality of air bubbles embedded in the low-density polyethylene outer middle layer;
(d) a high density polyethylene outer layer with a plurality of air bubbles embedded in the high density polyethylene outer layer; and
(e) a means for holding the layers together.

12. The device of claim 11 wherein the inner layer, inner middle layer, outer middle layer, and outer layer are perforated for breathability.

13. A method for protecting various areas of a user's body, which comprises adhering a self-adhesive pad to an area of the user's body for protecting said area.
